(19) United States
(12) Patent Application Publication
(10) Pub. No.: US 2013/0033115 A1
(43) Pub. Date: Feb. 7, 2013

(54) RE-COMBINER BOX OF PHOTOVOLTAIC SYSTEM

(71) Applicants: Seth Adam Cutler, Bridgeport, CT (US); Arunkumar Govindarajalou, Secunderabad (IN); Peter James Greenwood, Cheshire, CT (US); Geoffrey Hugh McKay, West Hartford, CT (US); Gary Paul Michaelis, Oakville, CT (US); Sachin Tulsidas Thakkar, Hyderabad (IN)

(72) Inventors: Seth Adam Cutler, Bridgeport, CT (US); Arunkumar Govindarajalou, Secunderabad (IN); Peter James Greenwood, Cheshire, CT (US); Geoffrey Hugh McKay, West Hartford, CT (US); Gary Paul Michaelis, Oakville, CT (US); Sachin Tulsidas Thakkar, Hyderabad (IN)

(73) Assignee: GENERAL ELECTRIC COMPANY, Schenectady, NY (US)

(21) Appl. No.: 13/195,069

(22) Filed: Aug. 1, 2011

(51) Int. Cl. H02J 1/10; H01H 21/56; H01R 43/00; H01H 3/08

(52) U.S. Cl. 307/85; 200/17 R; 200/15; 29/825

(57) ABSTRACT

An apparatus for a photovoltaic system in which multiple poles are connectable with multiple fuses is provided. The apparatus includes a rotor configured to occupy at least first and second rotational angles, a disconnect unit including a plurality of interrupter housings respectively configured to connect at least one of the multiple poles with at least one of the multiple fuses in accordance with a rotational angle of the rotor, at least one of the plurality of the interrupter housings being mutually connectable, a transmission unit disposed and configured to electrically combine the multiple poles into a lesser number of the multiple poles, a housing sized to house the rotor, the disconnect unit and the transmission unit and an actuator arm disposed at the exterior of the housing and configured to be selectively actuated to cause the rotor to occupy the at least one of the rotational angles.

### BACKGROUND OF THE INVENTION

The subject matter disclosed herein relates to a re-combiner box of a photovoltaic system.

Photovoltaic installations vary from site to site. Often, due to a lack of standardization and ad hoc installation procedures, each site will have its own unique wiring configuration with various components installed differently. This leads to many sites having an excessive number of installed components disposed in a confusing and inefficient configuration.

For example, a given photovoltaic installation may have 4 solar arrays that are each configured to transmit current along a group of, for example, 10 power lines to 4 first stage combiner boxes. Each of the 4 first stage combiner boxes combines its 10 power lines into a single combined power line. The 4 combined power lines are then wired to an inverter in which the direct current (DC) carried by the combined power lines is converted into alternating current (AC). Before reaching the inverter, however, a disconnect apparatus must be disposed downstream from the 4 combiner boxes so that the current carried by the power lines can be shut off if necessary. The disconnect apparatus is normally a stand-alone feature having a given number of disconnect modules that is unrelated to the number of the combiner boxes. That is, where 4 combiner boxes may be provided in the installation, the disconnect apparatus may include only 3 disconnect modules. The extra combiner box and power line thus requires that an additional disconnect apparatus be provided to shut off power from the additional combiner box. The additional disconnect apparatus may be configured to serve 3 poles with only 1 pole actually being used.

Thus, in the exemplary installation, the additional disconnect apparatus and/or any other additional components necessarily require additional wiring and installation procedures. Moreover, as the size and configuration of the exemplary installation change over time, the arrangement described herein may tend to become more complicated and inefficient.

### BRIEF DESCRIPTION OF THE INVENTION

According to one aspect of the invention, an apparatus for a photovoltaic system in which multiple poles are connectable with multiple fuses is provided. The apparatus includes a rotor configured to occupy at least first and second rotational angles, a disconnect unit including a plurality of interrupter housings respectively configured to connect at least one of the multiple poles with at least one of the multiple fuses in accordance with a rotational angle of the rotor, at least one of the plurality of the interrupter housings being mutually connectable, a transmission unit disposed and configured to electrically combine the multiple poles into a lesser number of the multiple poles such that respective amperages of the combined poles are additive, a housing sized to house the rotor, the disconnect unit and the transmission unit and an actuator arm disposed at the exterior of the housing and configured to be selectively actuated to cause the rotor to occupy the at least one of the rotational angles.

According to another aspect of the invention, a photovoltaic system having multiple fuses is provided and includes combiner boxes respectively coupled to groups of photovoltaic strings, each of the combiner boxes being configured to aggregate the electric current generated by the corresponding group of the photovoltaic strings into multiple poles and a re-combiner box electrically disposed downstream from the combiner boxes. The re-combiner box includes a rotor configured to occupy at least first and second rotational angles, a disconnect unit including a plurality of interrupter housings respectively configured to connect at least one of the multiple poles with at least a corresponding one of the multiple fuses in accordance with a rotational angle of the rotor, at least one of the plurality of the interrupter housings being mutually connectable, a transmission unit disposed and configured to electrically combine the multiple poles into a lesser number of the multiple poles such that respective amperages of the combined poles are additive, a housing sized to house the rotor, the disconnect unit and the transmission unit and an actuator arm disposed at the exterior of the housing and configured to be selectively actuated to cause the rotor to occupy the at least one of the rotational angles.

According to yet another aspect of the invention, a method of assembling a re-combiner box of a photovoltaic system is provided and includes assembling individual interrupter housings, forming re-combiner box housings of varying widths, forming rotors of varying lengths, receiving an order for a re-combiner box configured to serve a given number of poles in the photovoltaic system and assembling the re-combiner box with the given number of interrupter housings, a selected one of the re-combiner box housings selected as having a width in accordance with the given number of the interrupter housings and a selected one of the rotors selected as having a length in accordance with the given number of the interrupter housings.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a photovoltaic system;

FIG. 2 is a plan view of a re-combiner box of the photovoltaic system of FIG. 1;

FIG. 3 is a perspective view of a disconnect unit of the re-combiner box of FIG. 2;

FIG. 4 is a perspective view of an installation of a fuse box of the disconnect unit of FIG. 3

FIG. 5 is a perspective view of a rotor of the disconnect unit of FIG. 3;

FIG. 6 is a perspective view of a coupling mechanism of the re-combiner box of FIG. 2;

FIG. 7 is a side view of an actuator arm of the re-combiner box of FIG. 2;

FIG. 8 is a flow diagram illustration an assembly process of a re-combiner box in accordance with embodiments; and

FIG. 9 is a flow diagram illustrating a service process of a photovoltaic system in which a re-combiner box is installed in accordance with embodiments.

The detailed description explains embodiments of the invention, together with advantages and features, by way of example with reference to the drawings.

### DETAILED DESCRIPTION OF THE INVENTION

In accordance with aspects of the invention, photovoltaic (PV) systems and solar installations can be simplified and made less expensive by providing a re-combiner box with a safety switch disconnect unit. Doing so may decrease a number of components and wires that need to be run from photovoltaic strings to an inverter and may provide an end user with a commonly known interface for the switch. The re-combiner box may be configured for rooftop mounting as part of a PV installation or any other mounting and may include features such as ON/OFF labels that will allow for a quick indication of switch positions and additional features to prevent accidental turn on incidents.

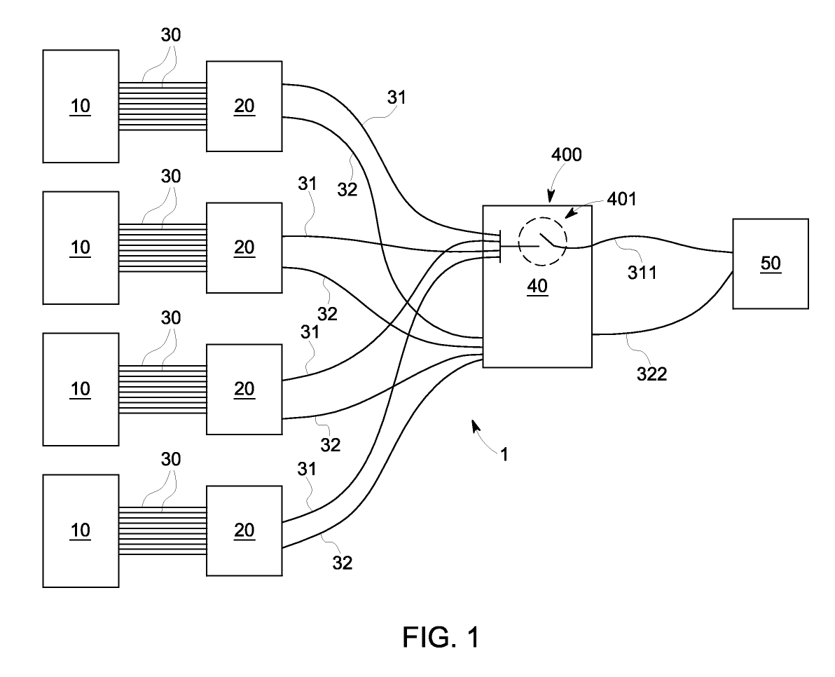

With reference to FIG. 1, a photovoltaic (PV) system 1 is provided and includes arrays of photovoltaic solar strings 10, each of which is configured to convert solar energy into direct electrical current (“DC current”), combiner boxes 20 and transmission lines 30, which are respectively configured to carry the DC current from the solar strings 10 to corresponding ones of the combiner boxes 20. Within each of the combiner boxes 20, the transmission lines 30 of an array of the photovoltaic solar strings 10 are combined into a pole having a positive pole component 31 and a negative pole component 32. At least one or more of the combiner boxes 20 may be associated with a pole of a unique amperage, whereby the positive and negative pole components 31, 32 of one combiner box 20 may be configured to carry, for example, 100 amps and the positive and negative pole components 31, 32 of another combiner box 20 may be configured to carry, for example, 200 amps.

In accordance with embodiments, the combiner boxes 20 may be grouped in groups of even numbers or, more particularly, in groups of four or more combiner boxes 20, as shown in FIG. 1. For purposes of clarity and brevity, the description provided herein will relate to the case of the combiner boxes 20 being grouped in groups of four, although it is to be understood that this configuration is merely exemplary and that other configurations are possible within the scope of the invention.

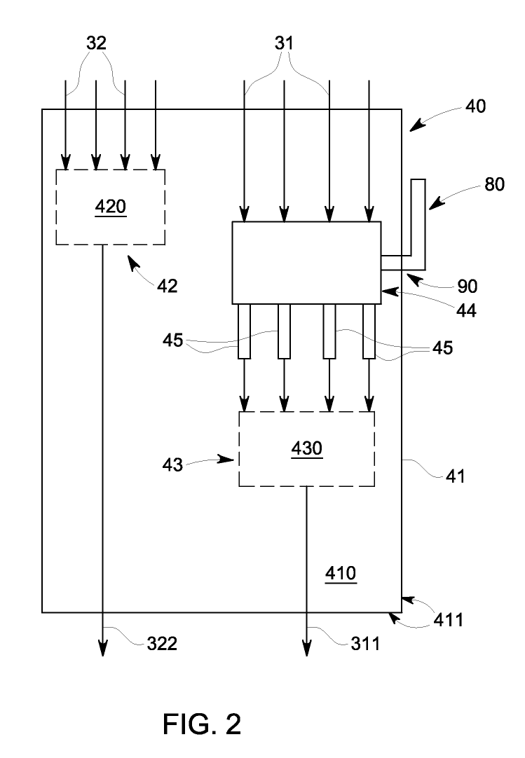

With reference to FIGS. 1 and 2, the positive and negative pole components 31, 32 of each of the four grouped combiner boxes 20 are wired into or otherwise electrically connected to a re-combiner box 40 of a disconnect apparatus 400 having a switch module 401. The re-combiner box 40 is configured such that the positive pole components 31 of various combiner boxes 20 can be combined together and such that the negative pole components 32 of the various combiner boxes 20 can be likewise combined together.

To this end, the re-combiner box 40 includes a re-combiner housing 41, a first electrical transmission unit 42, a second electrical transmission unit 43 and a disconnect unit 44, which may be electrically disposed upstream from, e.g., the second electrical transmission unit 43, and which serves as a component of the switch module. The re-combiner housing 41 includes a base 410 and a removable cover 411 formed such that the re-combiner housing 41 includes an interior and an exterior. The first and second electrical transmission units 42 are both disposed within the re-combiner housing 41 along with at least a portion of the disconnect unit 44. The first electrical transmission unit 42 may include a re-combiner lug 420, which is disposed and configured to electrically combine the four negative pole components 32 into a lesser number of negative pole components 322 (for the purposes of clarity and brevity, the number of negative poles will be one) such that the combined amperages of the combined negative pole components 32 are additive. The second electrical transmission unit 43 may similarly include a re-combiner lug 430, which is disposed and configured to electrically combine the four positive pole components 31 into one positive pole component 311 such that the combined amperages of the combined positive pole components 31 are also additive. The one negative pole component 322 and the one positive pole component 311 are each output from the re-combiner housing 41 and wired into or otherwise connected to an inverter 50. The inverter 50 converts the DC current carried by the one negative pole component 322 and the one positive pole component 311 into alternating current.

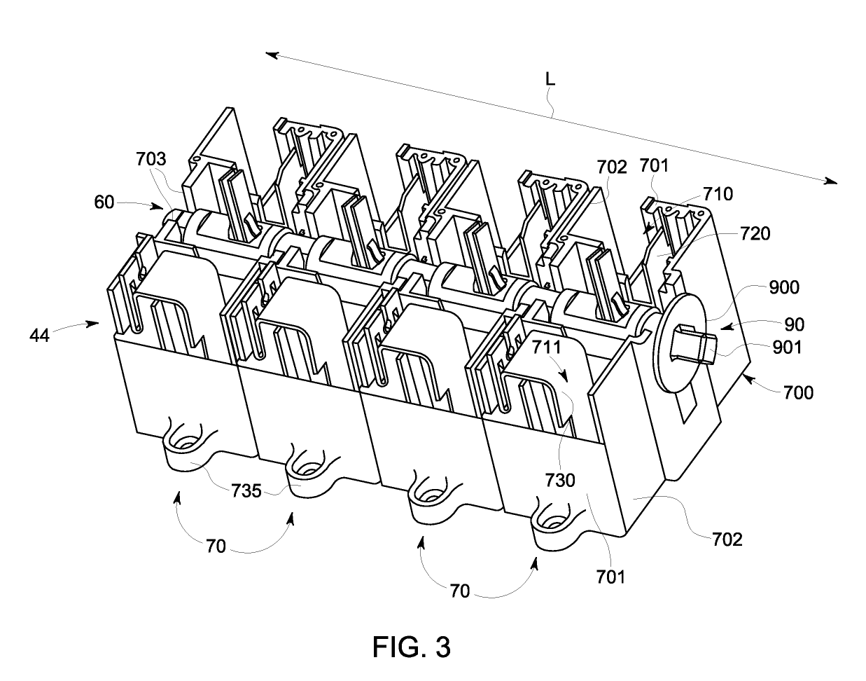

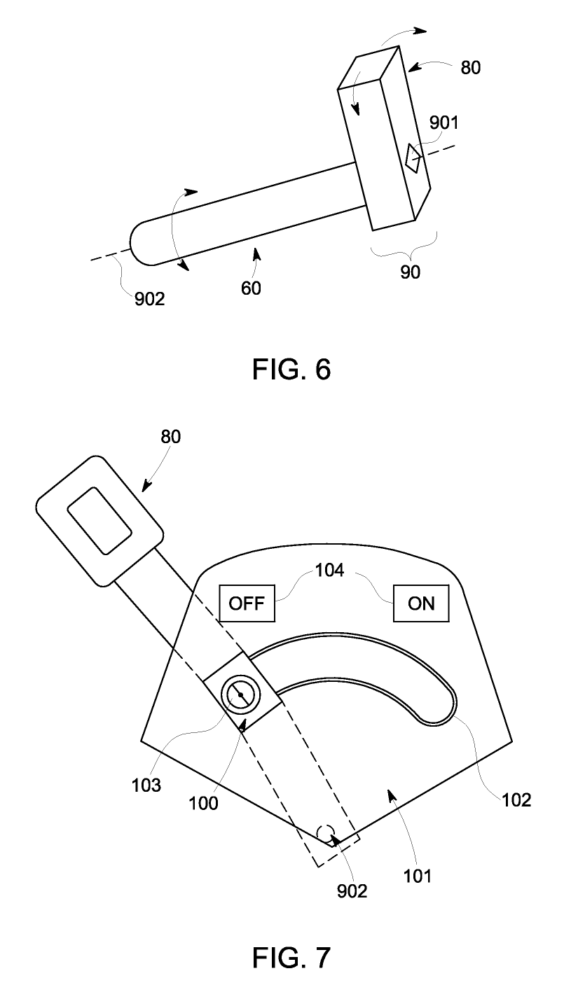

With reference to FIGS. 3-6, in addition to the re-combiner housing 41, the first and second electrical transmission units 42, 43 and the disconnect unit 44, the re-combiner box 40 further includes multiple fuses 45 for each one of the multiple poles of the PV system 1 and a rotor 60 extending through the disconnect unit 44 along a length, L, of the rotor 60.

The disconnect unit 44 may include a plurality of interrupter housings 70, an actuator arm 80 and a coupling mechanism 90. Each interrupter housing 70 is configured to house an interrupter unit, which may be a fuse, a switch or another similar current interruption device. At least one of the plurality of the interrupter housings 70 is configured to provide for a selective connection of at least one of the positive pole components 31 (or, in accordance with alternative embodiments, each of the negative pole components 32) to at least one corresponding one of the multiple fuses 45 or a selective disconnection of at least one of the positive pole components 31 from at least one corresponding one of the multiple fuses 45. At least one of the plurality of the interrupter housings 70 is further configured to be mutually connectable with for example one or two other interrupter housings 70 in a side-by-side array that can be added to or subtracted from in single interrupter housing modifications (i.e., an addition of a single interrupter housing 70 at a time or a subtraction of a single interrupter housing 70 at a time). This side-by-side array extends along the length, L, of the rotor 60. The actuator arm 80 is disposed externally from the re-combiner housing 41 and is configured to cause the connection or the disconnection of the positive poles 31 with respect to the corresponding ones of the multiple fuses 45 upon a selective actuation of the actuator arm 80 by an operator such as a fireman or technician. The coupling mechanism 90 connects the rotor 60 with the actuator arm 80.

As shown in FIG. 3, at least one of the plurality of the interrupter housings 70 includes a substantially rectangular structure 700 that has end walls 701 and sidewalls 702. Within the sidewalls 702, recesses 703 are defined to lockably receive the rotor 60, such that the rotor 60 is securable within the interrupter housings 70 and rotatable about a longitudinal axis thereof The rectangular structure 700 is therefore formed to define opposite end regions 710, 711 in which input leads 720 and outlet leads 730 are supportively disposed, respectively. The input leads 720 are disposed and configured for electrical coupling with the positive poles 31. The outlet leads 730 are disposed and configured for electrical coupling with the fuses 45. At least one of the plurality of the interrupter housings 70 also includes a foot portion 735 by which the interrupter housing 70 can be supportively affixed to the re-combiner box housing 41.

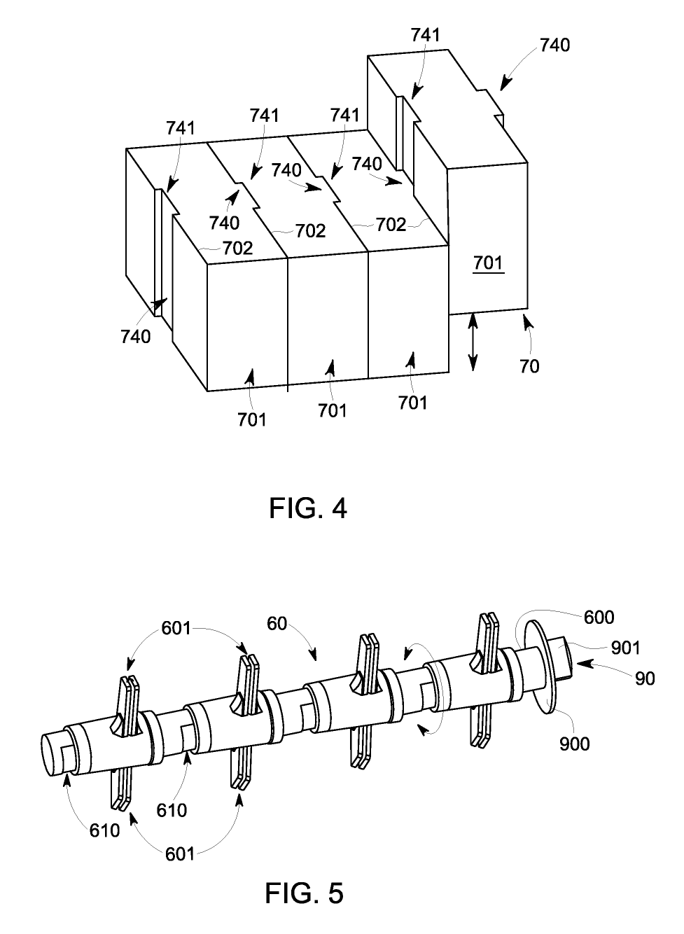

As shown in FIG. 4, the sidewalls 702 are each formed to define opposite complementary mating structures 740, 741 such that at least one of the plurality of the interrupter housings 70 is slidably attachable to an adjacent one of the plurality of the interrupter housings 70 and such that each one of the plurality of the interrupter housings 70 may be slidably attached to up to two adjacent ones of the plurality of the interrupter housings 70 on either side thereof to form the side-by-side array. In accordance with embodiments, the complementary mating structures 740, 741 may include interlocking dovetail and fir-tree features or similar types of interlocking features.

As shown in FIG. 5, the rotor 60 includes a main member 600, which is rotatable about a longitudinal axis thereof, from which pairs of rotor blades 601 extend in radially opposite directions. The rotor 60 is supportively disposed to extend through each one of the plurality of the interrupter housings 70 of the disconnect unit 44 such that the rotor blades 601 can be rotated into electrical coupling with the input leads 720 and the outlet leads 730. In particular, at an initial time with the main member 600 set to occupy a given first rotational angle, a half of each pair of the rotor blades 601 may be electrically decoupled from the input leads 720 and the other half of each pair may be electrically decoupled from the outlet leads 730. At a later time with the main member 600 having been rotated to occupy given second rotational angle (i.e., by 90 degrees), a half of each pair of the rotor blades 601 may be placed into electrical coupling with the input leads 720 and the other half of the rotor blades 601 may be placed into electrical coupling with the outlet leads 730.

The rotor 60 further includes mating sections 610 defined along the main member 600. The mating sections 610 allow the rotor 60 to be non-removably insertible into the recesses 703 of the interrupter housings 70. In accordance with embodiments, the mating sections 610 require that the rotor 60 be inserted into the recesses 703 at a specific insertion angle that is different from either the first or the second rotational angle. Once the rotor 60 is secured in the recesses 703, the rotor 60 may be rotated into one of the first or the second rotational angles as described above such that the rotor 60 does not return to the insertion angle unless service of the rotor 60 is required and such that the rotor 60 does not undesirably or unexpectedly disengage from the plurality of the interrupter housings 70.

With the plurality of the interrupter housings 70 being mutually connectable with one another in the side-by-side array in the single interrupter housing modifications, the disconnect unit 44 serves as a modular feature to which single interrupter housings 70 can be added or from which single interrupter housings 70 can be removed. Thus, various numbers of poles can be served by the re-combiner box 40 having varied numbers of interrupter housings 70 installed therein. Since the re-combiner housing 41 houses these components, the re-combiner housing 41 should have a width that is not overly large while allowing for the size of the disconnect unit 44 to be sized to serve at least a given of number of poles of a PV system and possibly to serve additional/lesser numbers of poles as modifications to the PV system are made.

With reference to FIGS. 3, 5, 6 and 7, the coupling mechanism 90 is disposed at an end of the main member 600 of the rotor 60 and may include, for example, a flange 900 and a squared end cap 901 of the rotor 60. The flange 900 may serve to axially secure the main member 600. The squared end cap 901 is connectable with the actuator arm 80 such that, as the actuator arm 80 is pivoted about pivot axis or point 902 of the coupling mechanism 90, the squared end cap 901 rotates as well and causes the main member 600 to rotate between the first and second rotational angles.

As shown in FIG. 7, the disconnect apparatus 400 further includes a pin mechanism 100. The pin mechanism 100 serves as a safety device for emergency responders, such as firemen, and is configured to prevent the actuation of the actuator arm 80 when the pin mechanism 100 is un-actuated and to permit actuation of the actuator arm 80 when the pin mechanism 100 is actuated. The pin mechanism 100 includes a pouch 101 having a guide slot 102 formed therein along an arc and a pin 103, which is operably disposed on the actuator arm 80 at the radial location of the guide slot 102. Thus, as the actuator arm 80 pivots about the pivot point 902, the pin 103 moves along the guide slot 102. The pin 103 is actuatable to move from a first position, at which movement of the pin 103 along the guide slot 102 is prevented, toward a second position, at which the pin 103 movement along the guide slot 102 is permitted. Thus, the actuator arm 80 cannot be pivoted unless the pin 103 is actuated.

An outer surface of the re-combiner housing 41 or a side of the pouch 101 facing toward an exterior may have ON/OFF labels 104 provided thereon. Such labels 104 may allow for easier identification and interpretation of the actuator arm 80 position. In particular, such labels 104 may make it easier for firefighters or other first responders to determine if the disconnect apparatus 400 is ON or OFF.

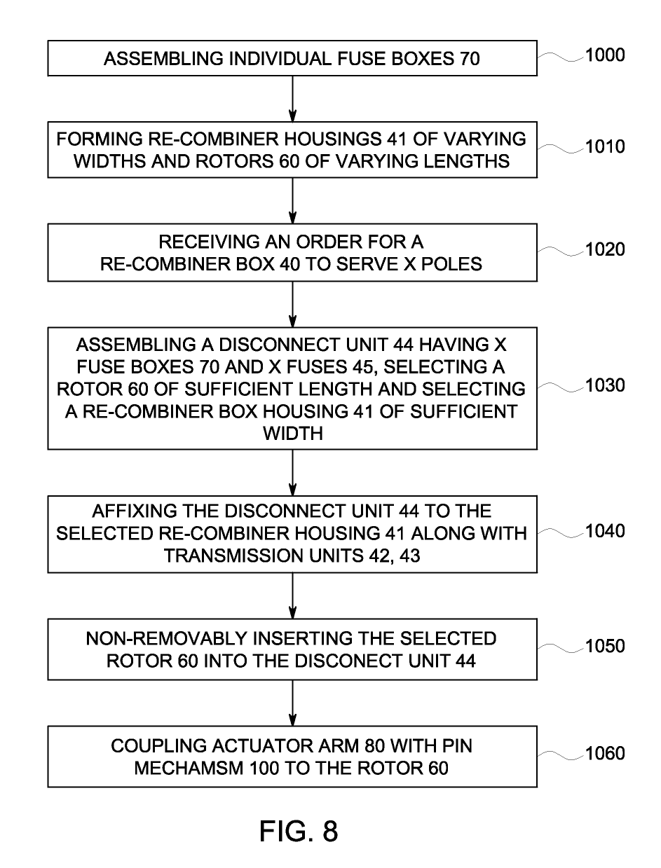

With reference to FIG. 8 and, in accordance with further aspects, an assembly process of a re-combiner box 40 is illustrated in accordance with embodiments. As shown, individual interrupter housings 70 are assembled 1000 and stored until they are needed for a given installation. Also, re-combiner housings 41 of varying widths and rotors 60 of varying lengths are formed 1010. At 1020, an order is received for a re-combiner box 40 to serve a given number, X, of poles and, at 1030, a disconnect unit 44 is assembled and a rotor 60 and a re-combiner box housing 41 are selected. The disconnect unit 44, as assembled, has X numbers of interrupter housings 70 and fuses 45 to correspond with the number of poles to be served. Meanwhile, the rotor 60 has a sufficient length to extend through the X interrupter housings 70 and the re-combiner box housing 41 has sufficient width to house each component.

At 1040, the assembled disconnect unit 44 is affixed to the selected re-combiner box housing 41 by, for example, fastening each foot portion 735 to the re-combiner box housing 41 (in an alternate embodiment, the foot portions 735 of the individual interrupter housings 70 could be fastened to the re-combiner box housing 41 as the disconnect unit 44 is assembled within the re-combiner box housing 41). At 1050, the selected rotor 60 is non-removably inserted into the interrupter housings 70 of the disconnect unit 44 and, at 1060, an actuator arm 80 with a pin mechanism 100 is coupled to the rotor 60.

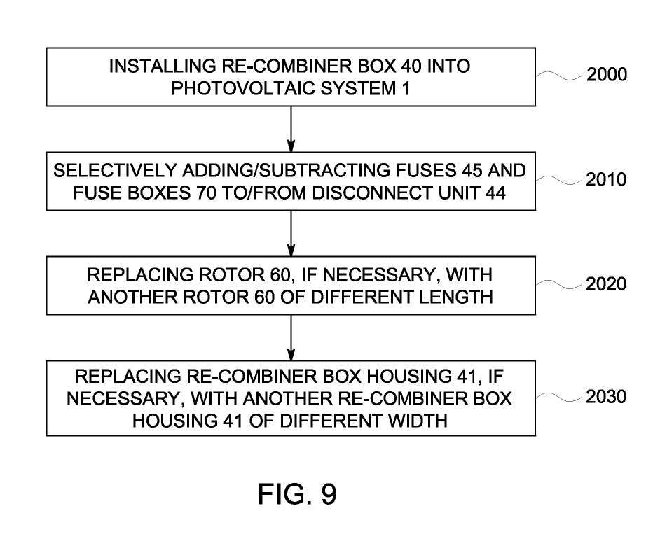

With reference to FIG. 9 and, in accordance with still further aspects, a service process of a PV system 1 in which a re-combiner box 40 is installed is illustrated in accordance with embodiments. At 2000, the re-combiner box 40 is installed into the PV system 1. Over time, if it is determined that the number of poles in the PV system 1 to be served needs to be changed, the number of fuses 45 and interrupter housings 70 will also need to be changed accordingly. Thus, at 2010, the number of fuses 45 and interrupter housings 70 is increased or decreased by adding or subtracting fuses 45 and interrupter housings 70 one-by-one. At 2020 and 2030, if it becomes clear that the rotor 60 is too short or too long and that the re-combiner box housing 41 is too narrow or too wide, these components can be selectively replaced.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An apparatus for a photovoltaic system in which multiple poles are connectable with multiple fuses, the apparatus comprising:
a rotor configured to occupy at least first and second rotational angles;
a disconnect unit comprising a plurality of interrupter housings respectively configured to connect at least one of the multiple poles with at one of the multiple fuses in accordance with a rotational angle of the rotor, at least one of the plurality of the interrupter housings being mutually connectable;
a transmission unit disposed and configured to electrically combine the multiple poles into a lesser number of the multiple poles such that respective amperages of the combined poles are additive;
a housing sized to house the rotor, the disconnect unit and the transmission unit; and
an actuator arm disposed at the exterior of the housing and configured to be selectively actuated to cause the rotor to occupy the at least one of the rotational angles.

2. The apparatus according to claim 1, wherein the at least one of the plurality of the interrupter housings is respectively connectable with the housing.

3. The apparatus according to claim 1, wherein the at least one of the plurality of the interrupter housings comprises:
an input lead, which is electrically coupled to a corresponding one of the multiple poles; and
an outlet lead, which is electrically coupled to a corresponding one of the multiple fuses.

4. The apparatus according to claim 3, wherein the rotor comprises rotor blades extending radially outwardly such that, when the rotor occupies the first and second rotational angles, the rotor blades electrically couple and decouple the input and outlet leads, respectively.

5. The apparatus according to claim 4, wherein the rotor is configured to be non-removably insertible into the plurality of the interrupter housings of the disconnect unit at an insertion angle, which is different from the first and second rotational angles.

6. The apparatus according to claim 1, wherein the at least one of the plurality of the interrupter housings comprises complementary mating structures on opposite sides thereof

7. The apparatus according to claim 1, wherein the at least one of the plurality of the interrupter housings is slidably attachable to an adjacent one of the plurality of the interrupter housings.

8. The apparatus according to claim 1, wherein the actuator arm comprises a pin mechanism configured to prevent actuation of the actuator arm unless the pin mechanism is selectively actuated.

9. A photovoltaic system having multiple fuses, comprising:
combiner boxes respectively coupled to groups of photovoltaic strings, each of the combiner boxes being configured to aggregate the electric current generated by the corresponding group of the photovoltaic strings into multiple poles; and
a re-combiner box electrically disposed downstream from the combiner boxes, the re-combiner box comprising:
a rotor configured to occupy at least first and second rotational angles;
a disconnect unit comprising a plurality of interrupter housings respectively configured to connect at least one of the multiple poles with at least one of the multiple fuses in accordance with a rotational angle of the rotor, at least one of the plurality of the interrupter housings being mutually connectable;
a transmission unit disposed and configured to electrically combine the multiple poles into a lesser number of the multiple poles such that respective amperages of the combined poles are additive;
a housing sized to house the rotor, the disconnect unit and the transmission unit; and
an actuator arm disposed at the exterior of the housing and configured to be selectively actuated to cause the rotor to occupy the at least one of the rotational angles.

10. The photovoltaic system according to claim 9, wherein at least one of the multiple poles has a unique amperage.

11. The photovoltaic system according to claim 9, wherein at least one of the multiple poles has a negative and a positive component, the transmission unit comprising:
a first transmission unit, which is disposed and configured to electrically combine the negative components of the at least one of the multiple poles into a single pole; and
a second transmission unit, which is disposed and configured to electrically combine the positive components of the at least one of the multiple poles into a single pole.

12. The photovoltaic system according to claim 9, further comprising an inverter electrically disposed downstream from the re-combiner box.

13. The photovoltaic system according to claim 9, wherein at least one of the plurality of the interrupter housings is respectively connectable with the housing.

14. The photovoltaic system according to claim 9, wherein at least one of the plurality of the interrupter housings comprises:
an input lead, which is electrically coupled to a corresponding one of the multiple poles; and
an outlet lead, which is electrically coupled to a corresponding one of the multiple fuses.

15. The photovoltaic system according to claim 14, wherein the rotor comprises rotor blades extending radially outwardly such that, when the rotor occupies first and second rotational angles, the rotor blades electrically couple and decouple the input and outlet leads, respectively.

16. The photovoltaic system according to claim 15, wherein the rotor is configured to be non-removably insertible into the interrupter housings of the disconnect unit at an insertion angle, which is different from the first and second rotational angles.

17. The photovoltaic system according to claim 9, wherein the at least one of the plurality of the interrupter housings comprises complementary mating structures on opposite sides thereof

18. The photovoltaic system according to claim 9, wherein the at least one of the plurality of the interrupter housings is slidably attachable to an adjacent one of the plurality of the interrupter housings.

19. The photovoltaic system according to claim 9, wherein the actuator arm comprises a pin mechanism configured to prevent actuation of the actuator arm unless the pin mechanism is selectively actuated.

20. A method of assembling a re-combiner box of a photovoltaic system, the method comprising:
assembling individual interrupter housings;
forming re-combiner box housings of varying widths;
forming rotors of varying lengths;
receiving an order for a re-combiner box configured to serve a given number of poles in the photovoltaic system; and
assembling the re-combiner box with the given number of interrupter housings, a selected one of the re-combiner box housings selected as having a width in accordance with the given number of the interrupter housings and a selected one of the rotors selected as having a length in accordance with the given number of the interrupter housings.

21. The method according to claim 20, further comprising adding or subtracting a interrupter housing to or from the re-combiner box one at a time.

22. The method according to claim 20, further comprising replacing the re-combiner box housing or the rotor with a re-combiner box housing or rotor of different width or length, respectively.
